(19) United States
(12) Patent Application Publication
(10) Pub. No.: US 2021/0195586 A1
(43) Pub. Date: Jun. 24, 2021

(54) METHOD BY WHICH BASE STATION AND TERMINAL TRANSMIT/RECEIVE SIGNAL IN WIRELESS COMMUNICATION SYSTEM, AND DEVICE FOR SUPPORTING SAME

(71) Applicant: LG ELECTRONICS INC., Seoul (KR)

(72) Inventors: Kijun KIM, Seoul (KR); Byounghoon KIM, Seoul (KR); Eunsun KIM, Seoul (KR); Suckchel YANG, Seoul (KR)

(73) Assignee: LG ELECTRONICS INC., Seoul (KR)

(21) Appl. No.: 16/077,719

(22) PCT Filed: Mar. 14, 2017
(86) PCT No.: PCT/KR2017/002729

§ 371 Date: Aug. 13, 2018

Related U.S. Application Data
(60) Provisional application No. 62/308,839, filed on Mar. 15, 2016.
(60) Provisional application No. 62/333,836, filed on May 10, 2016.

(51) Int. Cl. H04W 72/04

(52) U.S. Cl. CPC H04W 72/0446; H04W 72/0406

(57) ABSTRACT

A method by which a base station and a terminal transmit/receive a signal and a device for supporting the same are disclosed. More particularly, disclosed in the following explanation are: a method by which a terminal and a base station efficiently transmit/receive a signal by controlling, in units of groups, a newly proposed frame (or subframe) structure; and devices for supporting the same.

### TECHNICAL FIELD

The present invention relates to a wireless communication system, and more particularly, to methods for transmitting and receiving signals between a user equipment and a base station in a wireless communication system and devices for supporting the same.

More specifically, the present invention is directed to methods for allowing a user equipment and a base station to efficiently transmit and receive signals by controlling a newly proposed frame (or subframe) structure on a group basis and devices for supporting the same.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

### DISCLOSURE OF THE INVENTION

### Technical Task

The object of the present invention is to provide methods by which a base station and a user equipment efficiently transmit and receive signals.

In particular, the object of the present invention is to provide methods by which a base station and a user equipment configure resources for downlink transmission and reception and resources for uplink transmission and reception based on information on subframe groups, each of which comprises at least one subframe, and transmit and receive control information and data by using the configured resources.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

The present invention provides methods and devices for transmitting and receiving signals between a base station and a user equipment in a wireless communication system.

In an aspect of the present invention, provided herein is a method for transmitting and receiving signals to and from a base station (BS) by a user equipment (UE) in a wireless communication system. The method may include: receiving, from the BS, information on a length of a subframe group comprising at least one subframe; obtaining information on a configuration of the at least one subframe in the subframe group; receiving, from the BS, either or both of control information and data on downlink resources configured according to the configuration of the at least one subframe in the subframe group; and transmitting, to the BS, either or both of control information and data on uplink resources configured according to the configuration of the at least one subframe in the subframe group. In this case, the subframe group may include one guard period.

In another aspect of the present invention, provided herein is a user equipment (UE) for transmitting and receiving signals to and from a base station (BS) in a wireless communication system. The UE may include: a transmitter; a receiver; and a processor connected to the transmitter and the receiver. In this case, the processor may be configured to: receive, through the receiver from the BS, information on a length of a subframe group comprising at least one subframe; obtain information on a configuration of the at least one subframe in the subframe group; receive, through the receiver from the BS, either or both of control information and data on downlink resources configured according to the configuration of the at least one subframe in the subframe group; and transmit, through the transmitter to the BS, either or both of control information and data on uplink resources configured according to the configuration of the at least one subframe in the subframe group. At this time, the subframe group may include one guard period.

The information on the length of the subframe group may be transmitted via at least one of a Master Information Block (MIB), a System Information Block (SIB), a Paging CHannel (PCH), Radio Resource Control (RRC) signaling, and a Physical Downlink Control CHannel (PDCCH).

In addition, the information on the length of the subframe group may be transmitted at an interval of a predetermined number of subframe groups.

In this case, the subframe group may sequentially include the downlink resources, the guard period, and the uplink resources in a time domain.

In an embodiment according to the present invention, the information on the configuration of the at least one subframe in the subframe group may be obtained by receiving it from the BS.

In another embodiment according to the present invention, the information on the configuration of the at least one subframe in the subframe group may be obtained from a Physical Downlink Control CHannel (PDCCH) detected in the at least one subframe.

Additionally, when the subframe group sequentially includes three subframes: first, second, third subframes in a time domain and when grant information for a Physical Uplink Shared CHannel (PUSCH) in the second subframe or grant information for a PUSCH in the third subframe is detected in the first subframe of the subframe group, the first subframe may be set as a downlink resource and the second and third subframes may be set as uplink resources.

Additionally, locations of first downlink resources used by the UE to receive the control information from the BS, second downlink resources used by the UE to receive data from the BS, first uplink resources used by the UE to transmit the control information to the BS, and second uplink resources used by the UE to transmit the data to the BS may be configured based on the information on the configuration of the at least one subframe in the subframe group.

Additionally, the guard period may be allocated to two symbols in a time domain.

In a further aspect of the present invention, provided herein is a method for transmitting and receiving signals to and from a user equipment (UE) by a base station (BS) in a wireless communication system. The method may include: transmitting, to the UE, information on a length of a subframe group comprising at least one subframe; transmitting, to the UE, information on a configuration of the at least one subframe in the subframe group; transmitting, to the UE, either or both of control information and data on downlink resources configured according to the configuration of the at least one subframe in the subframe group; and receiving, from the UE, either or both of control information and data on uplink resources configured according to the configuration of the at least one subframe in the subframe group. In this case, the subframe group may include one guard period.

In a still further aspect of the present invention, provided herein is a base station (BS) for transmitting and receiving signals to and from a user equipment (UE) in a wireless communication system. The BS may include: a transmitter; a receiver; and a processor connected to the transmitter and the receiver. In this case, the processor may be configured to: transmit, through the transmitter to the UE, information on a length of a subframe group comprising at least one subframe; transmit, through the transmitter to the UE, information on a configuration of the at least one subframe in the subframe group; and transmit, through the transmitter to the UE, either or both of control information and data on downlink resources configured according to the configuration of the at least one subframe in the subframe group; and receive, through the receiver from the UE, either or both of control information and data on uplink resources configured according to the configuration of the at least one subframe in the subframe group. At this time, the subframe group may include one guard period.

The BS may transmit the information on the length of the subframe group and the information on the configuration of the at least one subframe in the subframe group to a neighboring BS.

In this case, the information on the length of the subframe group and the information on the configuration of the at least one subframe in the subframe group may be transmitted via an X2 interface or X2 signaling.

The described aspects of the present invention are merely part of the embodiments of the present invention. It will be appreciated by those skilled in the art that various modifications and alternatives could be developed from the following technical features of the present invention.

### Advantageous Effects

As is apparent from the above description, the embodiments of the present disclosure have the following effects.

According to the present invention, it is possible to improve the efficiency of signal transmission and reception between a BS and a UE in one or more subframes. More specifically, according to the present invention, since one or more subframes belonging to one subframe group includes only a single guard period, the transmission efficiency can be improved compared to the frame structure where a guard period is included in each subframe.

In addition, according to the present invention, information on the subframe group configuration applied to both a BS and a UE can be dynamically changed so that signals can also be dynamically transmitted.

The effects that can be achieved through the embodiments of the present invention are not limited to what has been particularly described hereinabove and other effects which are not described herein can be derived by those skilled in the art from the following detailed description. That is, it should be noted that the effects which are not intended by the present invention can be derived by those skilled in the art from the embodiments of the present invention.

### DESCRIPTION OF DRAWINGS

The accompanying drawings, which are included to provide a further understanding of the invention, provide embodiments of the present invention together with detail explanation. Yet, a technical characteristic of the present invention is not limited to a specific drawing. Characteristics disclosed in each of the drawings are combined with each other to configure a new embodiment. Reference numerals in each drawing correspond to structural elements.

FIG. 1 is a diagram illustrating physical channels and a signal transmission method using the physical channels;

FIG. 2 is a diagram illustrating exemplary radio frame structures;

FIG. 3 is a diagram illustrating an exemplary resource grid for the duration of a downlink slot;

FIG. 4 is a diagram illustrating an exemplary structure of an uplink subframe;

FIG. 5 is a diagram illustrating an exemplary structure of a downlink subframe;

FIG. 6 is a diagram illustrating a self-contained subframe structure applicable to the present invention;

FIGS. 7 and 8 are diagrams illustrating representative methods for connecting TXRUs to antenna elements;

FIG. 9 illustrates subframe groups according to an embodiment of the present invention;

FIG. 10 illustrates DL/UL configurations when an SFG has a length of two subframes according to another embodiment of the present invention;

FIG. 11 illustrates DL/UL configurations when an SFG has a length of four subframes according to a further embodiment of the present invention;

FIG. 12 illustrates a configuration where an SFG length is switched from four subframes to two subframes according to the present invention;

FIG. 13 illustrates SFG configurations according to the present invention when an SFG has a length of one subframe;

FIG. 14 illustrates frame configurations according to the present invention; and

FIG. 15 illustrates the configurations of a UE and a BS for implementing the proposed embodiments.

### BEST MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a User Equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmission end is a fixed and/or mobile node that provides a data service or a voice service and a reception end is a fixed and/or mobile node that receives a data service or a voice service. Therefore, a UE may serve as a transmission end and a BS may serve as a reception end, on an UpLink (UL). Likewise, the UE may serve as a reception end and the BS may serve as a transmission end, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331. That is, the steps or parts, which are not described to clearly reveal the technical idea of the present disclosure, in the embodiments of the present disclosure may be explained by the above standard specifications. All terms used in the embodiments of the present disclosure may be explained by the standard specifications.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

For example, the term, TxOP may be used interchangeably with transmission period or Reserved Resource Period (RRP) in the same sense. Further, a Listen-Before-Talk (LBT) procedure may be performed for the same purpose as a carrier sensing procedure for determining whether a channel state is idle or busy, CCA (Clear Channel Assessment), CAP (Channel Access Procedure).

Hereinafter, 3GPP LTE/LTE-A systems are explained, which are examples of wireless access systems.

The embodiments of the present disclosure can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE. While the embodiments of the present disclosure are described in the context of a 3GPP LTE/LTE-A system in order to clarify the technical features of the present disclosure, the present disclosure is also applicable to an IEEE 802.16e/m system, etc.

### 1. 3GPP LTE/LTE-A System

In a wireless access system, a UE receives information from an eNB on a DL and transmits information to the eNB on a UL. The information transmitted and received between the UE and the eNB includes general data information and various types of control information. There are many physical channels according to the types/usages of information transmitted and received between the eNB and the UE.

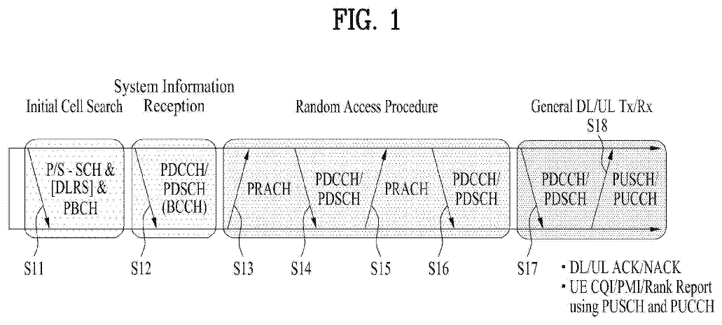

FIG. 1 illustrates physical channels and a general signal transmission method using the physical channels, which may be used in embodiments of the present disclosure.

When a UE is powered on or enters a new cell, the UE performs initial cell search (S11). The initial cell search involves acquisition of synchronization to an eNB. Specifically, the UE synchronizes its timing to the eNB and acquires information such as a cell Identifier (ID) by receiving a Primary Synchronization Channel (P-SCH) and a Secondary Synchronization Channel (S-SCH) from the eNB.

Then the UE may acquire information broadcast in the cell by receiving a Physical Broadcast Channel (PBCH) from the eNB.

During the initial cell search, the UE may monitor a DL channel state by receiving a Downlink Reference Signal (DL RS).

After the initial cell search, the UE may acquire more detailed system information by receiving a Physical Downlink Control Channel (PDCCH) and receiving a Physical Downlink Shared Channel (PDSCH) based on information of the PDCCH (S12).

To complete connection to the eNB, the UE may perform a random access procedure with the eNB (S13 to S16). In the random access procedure, the UE may transmit a preamble on a Physical Random Access Channel (PRACH) (S13) and may receive a PDCCH and a PDSCH associated with the PDCCH (S14). In the case of contention-based random access, the UE may additionally perform a contention resolution procedure including transmission of an additional PRACH (S15) and reception of a PDCCH signal and a PDSCH signal corresponding to the PDCCH signal (S16).

After the above procedure, the UE may receive a PDCCH and/or a PDSCH from the eNB (S17) and transmit a Physical Uplink Shared Channel (PUSCH) and/or a Physical Uplink Control Channel (PUCCH) to the eNB (S18), in a general UL/DL signal transmission procedure.

Control information that the UE transmits to the eNB is generically called Uplink Control Information (UCI). The UCI includes a Hybrid Automatic Repeat and reQuest Acknowledgement/Negative Acknowledgement (HARQ-ACK/NACK), a Scheduling Request (SR), a Channel Quality Indicator (CQI), a Precoding Matrix Index (PMI), a Rank Indicator (RI), etc.

In the LTE system, UCI is generally transmitted on a PUCCH periodically. However, if control information and traffic data should be transmitted simultaneously, the control information and traffic data may be transmitted on a PUSCH. In addition, the UCI may be transmitted aperiodically on the PUSCH, upon receipt of a request/command from a network.

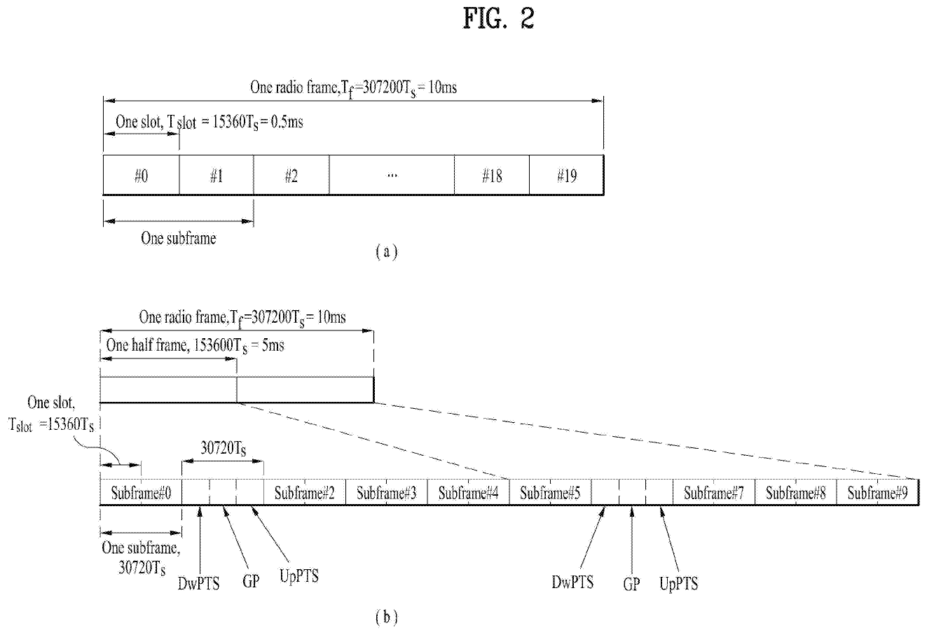

FIG. 2 illustrates exemplary radio frame structures used in embodiments of the present disclosure.

FIG. 2(a) illustrates frame structure type 1. Frame structure type 1 is applicable to both a full Frequency Division Duplex (FDD) system and a half FDD system.

One radio frame is 10 ms (Tf=307200·Ts) long, including equal-sized 20 slots indexed from 0 to 19. Each slot is 0.5 ms (Tslot=15360·Ts) long. One subframe includes two successive slots. An ith subframe includes 2ith and (2i+1)th slots. That is, a radio frame includes 10 subframes. A time required for transmitting one subframe is defined as a Transmission Time Interval (TTI). Ts is a sampling time given as Ts=1/(15 kHz×2048)=3.2552×10−8 (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

In a full FDD system, each of 10 subframes may be used simultaneously for DL transmission and UL transmission during a 10-ms duration. The DL transmission and the UL transmission are distinguished by frequency. On the other hand, a UE cannot perform transmission and reception simultaneously in a half FDD system.

The above radio frame structure is purely exemplary. Thus, the number of subframes in a radio frame, the number of slots in a subframe, and the number of OFDM symbols in a slot may be changed.

FIG. 2(b) illustrates frame structure type 2. Frame structure type 2 is applied to a Time Division Duplex (TDD) system. One radio frame is 10 ms (Tf=307200·Ts) long, including two half-frames each having a length of 5 ms (=153600·Ts) long. Each half-frame includes five subframes each being lms (=30720·Ts) long. An ith subframe includes 2ith and (2i+1)th slots each having a length of 0.5 ms (Tslot=15360·Ts). Ts is a sampling time given as Ts=1/(15 kHz×2048)=3.2552×10−8 (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

[Table 1] below lists special subframe configurations (DwPTS/GP/UpPTS lengths).

TABLE 1

| | Normal cyclic prefix in downlink | | | Extended cyclic prefix in downlink | | |
|---|---|---|---|---|---|---|
| | | UpPTS | | | UpPTS | |
| Special subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

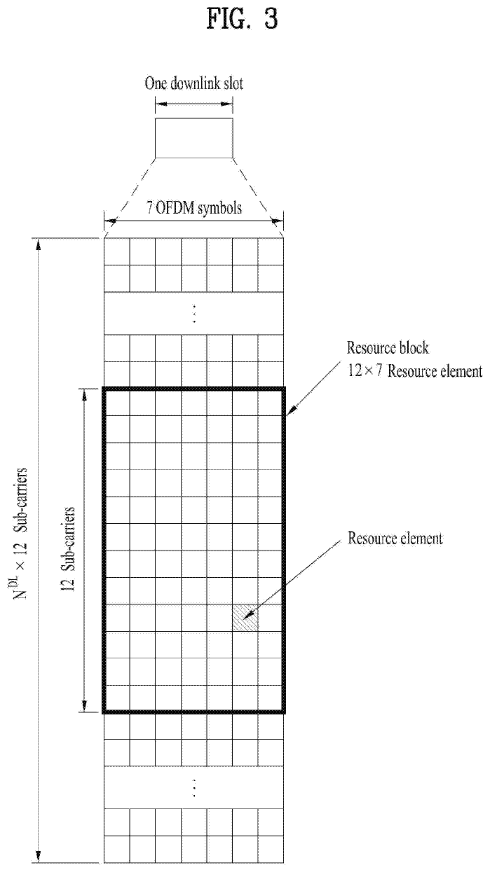

FIG. 3 illustrates an exemplary structure of a DL resource grid for the duration of one DL slot, which may be used in embodiments of the present disclosure.

Referring to FIG. 3, a DL slot includes a plurality of OFDM symbols in the time domain. One DL slot includes 7 OFDM symbols in the time domain and an RB includes 12 subcarriers in the frequency domain, to which the present disclosure is not limited.

Each element of the resource grid is referred to as a Resource Element (RE). An RB includes 12×7 REs. The number of RBs in a DL slot, NDL depends on a DL transmission bandwidth. The structure of the uplink slot may be the same as the structure of the downlink slot.

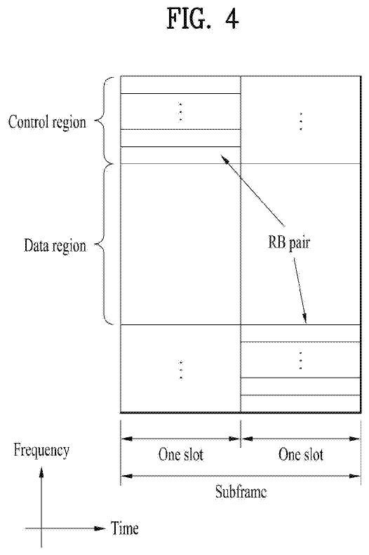

FIG. 4 illustrates a structure of a UL subframe which may be used in embodiments of the present disclosure.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe are allocated to a PUCCH for a UE. The RBs of the RB pair occupy different subcarriers in two slots. Thus it is said that the RB pair frequency-hops over a slot boundary.

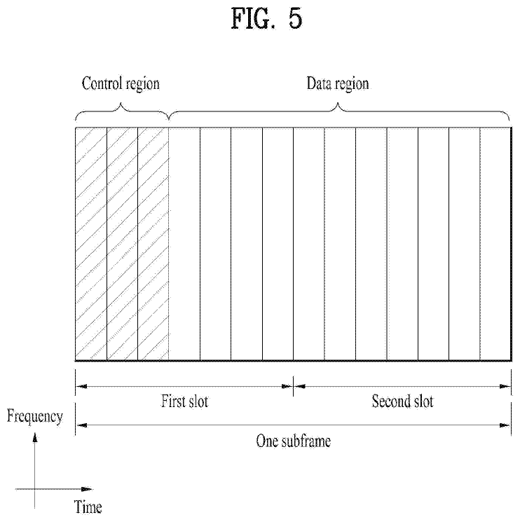

FIG. 5 illustrates a structure of a DL subframe that may be used in embodiments of the present disclosure.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e. the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

### 2. New Radio Access Technology System

As more and more communication devices require greater communication capacity, there is a need for mobile broadband communication enhanced over existing radio access technology (RAT). Massive Machine-Type Communications (MTC), which provides a variety of services by connecting multiple devices and objects anywhere and anytime, is also considered. In addition, communication system design considering services/UEs sensitive to reliability and latency is also under discussion.

Thus, introduction of a new radio access technology considering enhanced mobile broadband communication, massive MTC, and Ultra-Reliable and Low Latency Communication (URLLC) is being discussed. In the present invention, for simplicity, this technology will be referred to as New RAT.

2.1. Self-Contained Subframe Structure

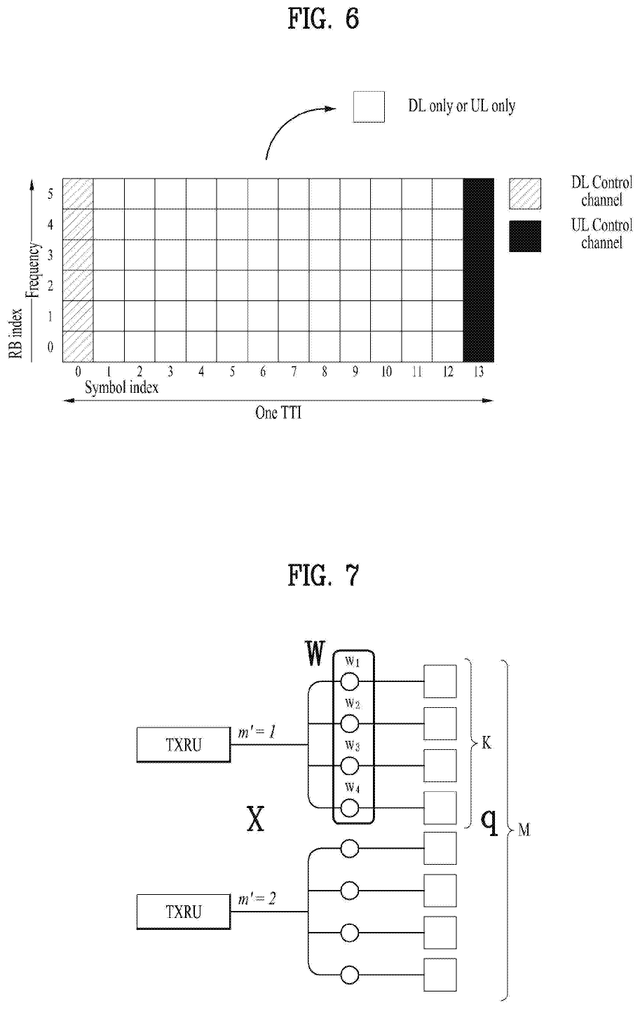

FIG. 6 is a diagram illustrating a self-contained subframe structure applicable to the present invention.

In the New RAT system to which the present invention is applicable, a self-contained subframe structure as shown in FIG. 6 is proposed in order to minimize data transmission latency in the TDD system.

In FIG. 6, the hatched region (e.g., symbol index=0) represents a downlink control region, and the black region (e.g., symbol index=13) represents an uplink control region. The other region (e.g., symbol index=1 to 12) may be used for downlink data transmission or for uplink data transmission.

In this structure, DL transmission and UL transmission may be sequentially performed in one subframe. In addition, DL data may be transmitted and received in one subframe and UL ACK/NACK therefor may be transmitted and received in the same subframe. As a result, this structure may reduce time taken to retransmit data when a data transmission error occurs, thereby minimizing the latency of final data transmission.

In such a self-contained subframe structure, a time gap having a certain time length is required in order for the base station and the UE to switch from the transmission mode to the reception mode or from the reception mode to the transmission mode. To this end, some OFDM symbols at the time of switching from DL to UL in the self-contained subframe structure may be set as a guard period (GP).

While a case where the self-contained subframe structure includes both the DL control region and the UL control region has been described above, the control regions may be selectively included in the self-contained subframe structure. In other words, the self-contained subframe structure according to the present invention may include not only the case of including both the DL control region and the UL control region but also the case of including either the DL control region or the UL control region alone as shown in FIG. 6.

For simplicity of explanation, the frame structure configured as above is referred to as a subframe, but this configuration can also be referred to as a frame or a slot. For example, in the New RAT system, one unit consisting of a plurality of symbols may be referred to as a slot. In the following description, a subframe or a frame may be replaced with the slot described above.

2.2. OFDM Numerology

The New RAT system uses the OFDM transmission scheme or a similar transmission scheme. Here, the New RAT system may typically have the OFDM numerology as shown in Table 2.

TABLE 2

| Parameter | Value | |
|---|---|---|
| Subcarrier-spacing (Δf) | 75 | kHz |
| OFDM symbol length | 13.33 | μs |
| Cyclic Prefix(CP) length | 1.04 us/0.94 μs | |
| System BW | 100 | MHz |
| No. of available subcarriers | 1200 | |
| Subframe length | 0.2 | ms |
| Number of OFDM symbol per Subframe | 14 | symbols |

Alternatively, the New RAT system may use the OFDM transmission scheme or a similar transmission scheme, and may use an OFDM numerology selected from among multiple OFDM numerologies as shown in Table 3. Specifically, as disclosed in Table 3, the New RAT system may take the 15 kHz subcarrier-spacing used in the LTE system as a base, and use an OFDM numerology having subcarrier-spacing of 30, 60, and 120 kHz, which are multiples of the 15 kHz subcarrier-spacing.

In this case, the cyclic prefix, the system bandwidth (BW) and the number of available subcarriers disclosed in Table 3 are merely an example that is applicable to the New RAT system according to the present invention, and the values thereof may vary depending on the implementation method. Typically, for the 60 kHz subcarrier-spacing, the system bandwidth may be set to 100 MHz. In this case, the number of available subcarriers may be greater than 1500 and less than 1666. Also, the subframe length and the number of OFDM symbols per subframe disclosed in Table 3 are merely an example that is applicable to the New RAT system according to the present invention, and the values thereof may vary depending on the implementation method.

TABLE 3

| Parameter | Value | | Value | | Value | | Value | |
|---|---|---|---|---|---|---|---|---|
| Subcarrier-spacing | 15 | kHz | 30 | kHz | 60 | kHz | 120 | kHz |
| (Δf) | | | | | | | | |
| OFDM symbol length | 66.66 | | 33.33 | | 16.66 | | 8.33 | |
| Cyclic Prefix(CP) | 5.20 μs/4.69 μs | | 2.60 μs/2.34 μs | | 1.30 μs/1.17 μs | | 6.51 μs/5.86 μs | |
| length | | | | | | | | |
| System BW | 20 | MHz | 40 | MHz | 80 | MHz | 160 | MHz |
| No. of available | 1200 | | 1200 | | 1200 | | 1200 | |
| subcarriers | | | | | | | | |
| Subframe length | 1 | ms | 0.5 | ms | 0.25 | ms | 0.125 | ms |
| Number of OFDM | 14 | symbols | 14 | symbols | 14 | symbols | 14 | symbols |
| symbol per Subframe | | | | | | | | |

2.3. Analog Beamforming

In a millimeter wave (mmW) system, since a wavelength is short, a plurality of antenna elements can be installed in the same area. That is, considering that the wavelength at 30 GHz band is 1 cm, a total of 100 antenna elements can be installed in a 5*5 cm panel at intervals of 0.5 lambda (wavelength) in the case of a 2-dimensional array. Therefore, in the mmW system, it is possible to improve the coverage or throughput by increasing the beamforming (BF) gain using multiple antenna elements.

In this case, each antenna element can include a transceiver unit (TXRU) to enable adjustment of transmit power and phase per antenna element. By doing so, each antenna element can perform independent beamforming per frequency resource.

However, installing TXRUs in all of the about 100 antenna elements is less feasible in terms of cost. Therefore, a method of mapping a plurality of antenna elements to one TXRU and adjusting the direction of a beam using an analog phase shifter has been considered. However, this method is disadvantageous in that frequency selective beamforming is impossible because only one beam direction is generated over the full band.

To solve this problem, as an intermediate form of digital BF and analog BF, hybrid BF with B TXRUs that are fewer than Q antenna elements can be considered. In the case of the hybrid BF, the number of beam directions that can be transmitted at the same time is limited to B or less, which depends on how B TXRUs and Q antenna elements are connected.

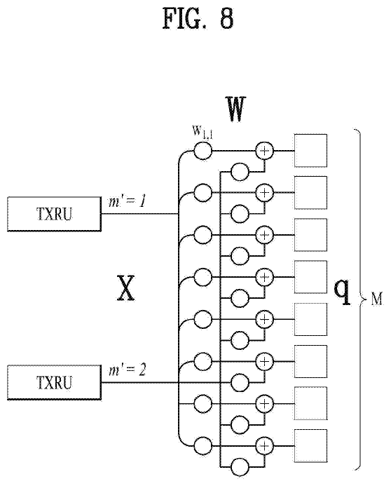

FIGS. 7 and 8 are diagrams illustrating representative methods for connecting TXRUs to antenna elements. Here, the TXRU virtualization model represents the relationship between TXRU output signals and antenna element output signals.

FIG. 7 shows a method for connecting TXRUs to sub-arrays. In FIG. 7, one antenna element is connected to one TXRU.

Meanwhile, FIG. 8 shows a method for connecting all TXRUs to all antenna elements. In FIG. 8, all antenna element are connected to all TXRUs. In this case, separate addition units are required to connect all antenna elements to all TXRUs as shown in FIG. 8.

In FIGS. 7 and 8, W indicates a phase vector weighted by an analog phase shifter. That is, W is a major parameter determining the direction of the analog beamforming. In this case, the mapping relationship between CSI-RS antenna ports and TXRUs may be 1:1 or 1-to-many.

The configuration shown in FIG. 7 has a disadvantage in that it is difficult to achieve beamforming focusing but has an advantage in that all antennas can be configured at low cost.

On the contrary, the configuration shown in FIG. 8 is advantageous in that beamforming focusing can be easily achieved. However, since all antenna elements are connected to the TXRU, it has a disadvantage of high cost.

2.4. CSI Feedback

In the 3GPP LTE or LTE-A system, user equipment (UE) has been defined to report channel state information (CSI) to a base station (BS or eNB). Herein, the CSI refers to information indicating the quality of a radio channel (or link) formed between the UE and an antenna port.

For example, the CSI may include a rank indicator (RI), a precoding matrix indicator (PMI), and a channel quality indicator (CQI).

Here, RI denotes rank information about the corresponding channel, which means the number of streams that the UE receives through the same time-frequency resource. This value is determined depending on the channel's Long Term Fading. Subsequently, the RI may be fed back to the BS by the UE, usually at a longer periodic interval than the PMI or CQI.

The PMI is a value reflecting the characteristics of a channel space and indicates a precoding index preferred by the UE based on a metric such as SINR.

The CQI is a value indicating the strength of a channel, and generally refers to a reception SINR that can be obtained when the BS uses the PMI.

In the 3GPP LTE or LTE-A system, the base station may set a plurality of CSI processes for the UE, and receive a report of the CSI for each process from the UE. Here, the CSI process is configured with a CSI-RS for specifying signal quality from the base station and a CSI-interference measurement (CSI-IM) resource for interference measurement.

### 3. Proposed Embodiment

In the embodiments of the present invention, all subframe may be composed of the self-contained subframe shown in FIG. 6 in order to reduce data transmission latency. However, this structure has a disadvantage in that guard period overhead significantly increases. For example, when one subframe is composed of 14 OFDM symbols (hereinafter “OFDM symbol” is abbreviated as “OS”), if the GP has a length of 2 OSs, the GP overhead is 14%. In addition, if one OS is allocated for PDCCH transmission and another OS is allocated for PUCCH transmission, only 10 OSs, that is, 71% of one subframe are used for data transmission. That is, the structure has a disadvantage in that the transmission efficiency decreases.

To improve the disadvantage, the present invention proposes a method for forming groups, each of which is composed of multiple subframes, and switching the signal transmission direction from DL to UL once in each subframe group. Accordingly, the present invention proposes that one GP is included in each subframe group.

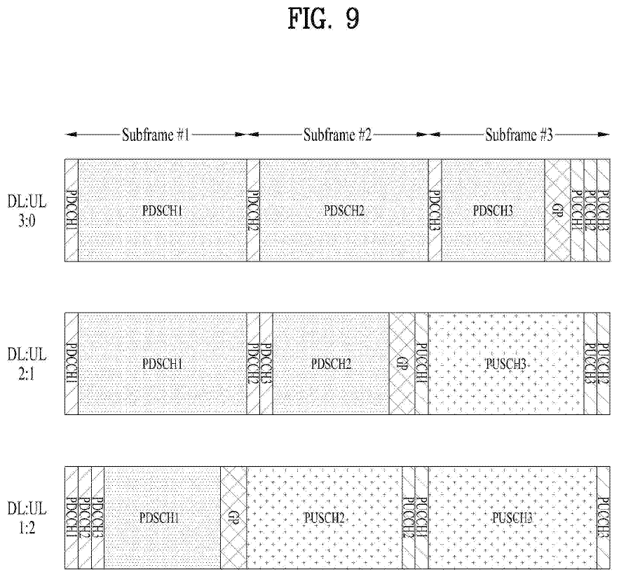

FIG. 9 illustrates subframe groups according to an embodiment of the present invention.

Specifically, FIG. 9 illustrates an example of dynamically adjusting or controlling DL data transmission subframes and UL data transmission subframes when one subframe group is composed of three subframes. In this case, a BS may inform a UE of the DL/UL configuration of a Sub-Frame Group (SFG) through a PDCCH transmitted in the starting subframe of the corresponding SFG.

When one SFG is composed of three subframes, three types of DL/UL configurations can be applied as shown in FIG. 9.

Specifically, in the time domain, a PDCCH can be always allocated to the front of the SFG, and a PUCCH can be always allocated to the back of the SFG. In this case, the first subframe of the SFG with the following ratio: [DL:UL]=[3:0], [2:1], or [1:2] can be always used as a PDSCH transmission resource. The PDSCH transmission region may be allocated starting from the first subframe of the SFG, whereas the PUSCH transmission region may be allocated starting from the last subframe of the SFG.

In FIG. 9, PDSCHn means the PDSCH transmitted in the nth subframe of the SFG, and PUSCHn means the PUSCH transmitted in the nth subframe of the SFG. In this case, PDCCHn is used to transmit scheduling DCI that informs transmission of PDSCHn or grant DCI that allows transmission of PUSCHn. In addition, PUCCHn is used to transmit ACK/NACK feedback information depending on reception of PDSCHn, or it is used to transmit CSI or a Sounding Reference Signal (SRS), which is requested by grant DCI of PDCCHn.

Although FIG. 9 shows that one channel is transmitted in each time period, the invention can be applied when multiple channels are transmitted through Frequency Division Multiplexing (FDM). For example, the BS may transmit a plurality of PDSCHs to multiple UEs in an FDM manner during the PDSCH1 transmission period. In addition, the BS may transmit a plurality of PDCCHs to multiple UEs in an FDM manner during the PDCCH1 transmission period. Moreover, the BS may receive a plurality of PUCCHs from multiple UEs in an FDM manner during the PUCCH1 transmission period. In this case, the plurality of PUCCHs may be Frequency Division Multiplexed (FDMed) for transmission thereof.

In the [3:1] configuration of FIG. 9, PDCCH1, PDCCH2, and PDCCH3 are used for transmitting scheduling DCI for PDSCH1, PDSCH2, and PDSCH3, respectively. In addition, PUCCH1, PUCCH2, and PUCCH3 may be used for transmitting ACK/NACK feedback information depending on reception of PDSCH1, PDSCH2, and PDSCH3, respectively. Moreover, PUCCH1, PUCCH2, and PUCCH3 may be used for transmitting CSI or SRSs requested by grant DCI of PDCCH1, PDCCH2, and PDCCH3, respectively.

In the [2:1] configuration of FIG. 9, PDCCH1 and PDCCH2 are used for transmitting scheduling DCI for PDSCH1 and PDSCH2, respectively. PDCCH3 is used as a resource for transmitting grant DCI that allows transmission of PUSCH3. In addition, PUCCH1 and PUCCH2 may be used for transmitting ACK/NACK feedback information depending on reception of PDSCH1 and PDSCH2, respectively. Moreover, PUCCH1, PUCCH2, and PUCCH3 may be used for transmitting CSI or SRSs requested by grant DCI of PDCCH1, PDCCH2, and PDCCH3, respectively. Thus, if there is no request for CSI reporting or SRS transmission through grant DCI of PDCCH3, no resources may be configured for PUCCH3.

In the [1:2] configuration of FIG. 9, PDCCH1 is used for transmitting scheduling DCI for PDSCH1. PDCCH2 and PDCCH3 are used as resources for transmitting grant DCI that allows transmission of PUSCH2 and PUSCH3, respectively. In addition, PUCCH1, PUCCH2, and PUCCH3 may be used for transmitting CSI or SRSs requested by grant DCI of PDCCH1, PDCCH2, and PDCCH3, respectively. Thus, if there is no request for CSI reporting or SRS transmission through grant DCI of PDCCH2 and PDCCH3, no resources may be configured for PUCCH2 and PUCCH3.

Additionally, although it is not shown in FIG. 9, the [0:3] configuration can be applied to the SFG. In the [0:3] configuration, PDCCH1, PDCCH2, and PDCCH3 are used as resources for transmitting grant DCI that allows transmission of PUSCH1, PUSCH2, and PUSCH3, respectively. In addition, PUCCH1, PUCCH2, and PUCCH3 may be used for transmitting CSI or SRSs requested by grant DCI of PDCCH1, PDCCH2, and PDCCH3, respectively. Thus, if there is no request for CSI reporting and SRS transmission through grant DCI of PDCCH1, PDCCH2, and PDCCH3, no resources may be configured for PUCCH1, PUCCH2, and PUCCH3.

Further, in the [3:0] configuration of FIG. 9, ACK/NACK feedback information that depends on reception of PDSCH1 and PDSCH2 may be transmitted on PUCCH1 and PUCCH2 of the same SFG. On the other hand, by considering the decoding processing time, ACK/NACK feedback information that depends on reception of PDSCH3 may be transmitted on PUCCH3 of the next SFG. This can be generalized as follows. The BS may inform the UE whether ACK/NACK feedback information depending on reception of PDSCHn will be transmitted in PUCCHn of the same SFG or PUCCHn of the next SFG.

In this embodiment of the present invention, the BS may explicitly inform the UE of the DL/UL configuration of a corresponding SFG through a PDCCH carrying common DCI, which is broadcasted to all the UEs, or a separate channel configured to carry the common DCI. In this case, the broadcasted common DCI may be transmitted on the resources for PDCCH1. Alternatively, the BS may explicitly inform the UE of the DL/UL configuration of a corresponding SFG through every PDCCH carrying dedicated DCI, which is transmitted to each UE, In this case, the dedicated DCI transmitted to each UE may be transmitted on resources for PDCCHn of the SFG. Alternatively, instead of explicitly informing the UE of the DL/UL configuration, the BS may inform the UE of a configuration to be used for the next subframe, that is, whether it is for either DL or UL.

As another embodiment, the UE may check the DL/UL configuration in an implicit manner from the locations where PDCCH2 and PDCCH3 are detected.

Specifically, the UE attempts to detect PDCCH2 and PDCCH3 in the first subframe. If either PDCCH2 or PDCCH3 is detected, the UE may know that the configuration of the corresponding SFG is either the [1:2] configuration or [0:3] configuration.

Alternatively, if PDCCH2 and PDCCH3 are not detected in the first subframe, the UE may attempt to detect PDCCH2 and PDCCH3 in the second subframe. If PDCCH2 and PDCCH3 are not detected in the second subframe, the UE may know that the configuration of the corresponding SFG is the [2:1] configuration. If only PDCCH2 is detected in the second subframe, the UE may know that the configuration of the corresponding SFG is the [3:0] configuration.

In addition, upon receiving scheduling DCI of PDSCH1 through PDCCH1, the UE may know which subframe PUCCH1 for carrying ACK/NACK feedback information depending on reception of PDSCH1 is located in from the scheduling DCI of PDSCH1. For example, if the BS informs the UE that PUCCH1 for carrying the ACK/NACK feedback information depending on the reception result of PDSCH1 is located in the third subframe of the SFG, the UE may know that the configuration of the corresponding SFG is the [3:0] configuration.

FIG. 9 illustrates that PDCCHn is Time Division Multiplexed (TDMed) with PDCCHm. However, according to a modification example of the present invention, PDCCHn can be FDMed with PDCCHm. In this case, the BS may inform the UE which subframe the DCI transmitted on a corresponding PDCCH is for. That is, if an SFG has 3-length as shown in FIG. 9, UL grant DCI transmitted on the PDCCH of the first subframe of the SFG may indicate that the DCI is for which PUSCH to be transmitted in which subframe (e.g., second or third subframe). This can be generalized as follows. If an SFG has N-length, UL grant DCI transmitted on the PDCCH of the first subframe of the SFG may indicate that the DCI is for which PUSCH to be transmitted in which subframe (e.g., second to Nth subframes), and UL grant DCI transmitted on the PDCCH of the second subframe of the SFG may indicate that the DCI is for which PUSCH to be transmitted in which subframe (e.g., third to Nth subframes).

According to another proposed method, the BS may determine a configuration of an SFG and then inform the UE of the configuration of the SFG. For example, the BS may transmit, to the UE, information on the length of the SFG, that is, how many subframes are included in the SFG. The information on the SFG length may be included in the Master Information Block (MIB), which is transmitted on the PBCH, so that the UE can obtain the information during the initial cell access procedure. Alternatively, the information on the SFG length may be transmitted to the UE via the System Information Block (SIB) or Radio Resource Control (RRC) signaling.

In addition, the BS may determine resources (e.g., OFDM symbol) for transmitting physical channels for each DL/UL configuration and then inform the UE of the determined resources. The OFDM symbols for transmitting PDCCHn and PUCCHn shown in FIG. 9 are merely an example, and PDCCHn and PUCCHn may be transmitted in different OFDM symbols. Thus, the BS may inform the UE of the locations of resources for transmitting PDCCHn and PUCCHn for each DL/UL configuration through the SIB or RRC signaling.

Alternatively, the BS may set a candidate set for the locations of the resources for transmission of PDCCHn and PUCCHn for each DL/UL configuration and then inform the UE of the candidate set through the SIB or RRC signaling. In this case, the UE may determine whether PDCCHn is transmitted or not by performing blind detection at the candidate locations where the transmission of PDCCHn is expected and then receive corresponding PDCCHn. In addition, the BS may inform the UE which location among the candidate locations PUCCHn is transmitted at through scheduling DCI or grant DCI. In this case, the locations of the resources for the transmission of PDCCHn and PUCCHn may be independently indicated according to the value of n.

Moreover, the BS may inform the UE of a set of transmission formats corresponding to the locations of the resources for the transmission of PDSCHn and PUSCHn (e.g., starting and last OFDM Symbols (OSs)) per DL/UL configuration through the SIB or RRC signaling. In this case, the BS may inform the UE which transmission format of PDSCH has been transmitted or which transmission format of PUSCH should be transmitted through scheduling DCI or grant DCI. The set of the transmission formats for PDSCHn and PUSCHn may be independently indicated according to the value of n.

In the proposed method according to the present invention, since the first subframe of the SFG is set to a subframe for DL data transmission, the BS may transmit important information (e.g., SIB, information on paging, etc.) in the first subframe of the SFG. In addition, since important information is transmitted in the first subframe of the SFG, the UE operating in Discontinuous Reception (DRX) mode may wake up at every predetermined period of time and receive PDCCH1 of the first subframe of the SFG.

As shown in FIG. 9, since in the time domain, the front portion of the SFG is used for DL transmission and the back portion thereof is used for UL transmission, the SFG configuration according to the present invention can mitigate interference between neighboring cells in a synchronized network. In other words, this SFG configuration may mitigate BS-to-BS interference, which occurs when neighboring BSs have different transmission directions, or UE-to-UE interference.

In addition, in an embodiment according to the present invention, a BS may perform an inter-cell negotiation process for matching SFG lengths with a neighboring BS via X2 signaling of an inter-cell X2 interface. In this case, the BS may transmit information on a DL/UL configuration to be used for each SFG to the neighboring BS.

If the X2 interface between the BSs has a large delay, the BS may transmit indicators for individual DL/UL configurations to be used for a certain amount of time to the neighboring BS in order to inform the neighboring BS of the DL/UL configurations via X2 signaling. Alternatively, the BS may transmit information on the probability that each subframe of the SFG is used for DL transmission to the neighboring BS.

For example, if an SFG is composed of three subframes, a specific BS may inform a neighboring BS of the probability (P1, P2, and P3) that each subframe of the SFG is used for DL transmission. Here, Pn is the probability that the nth subframe of the SFG is used for DL transmission. If it is desired that the three DL/UL configurations of FIG. 9 have the same probability, P1, P2, and P3 can be set to 100%, 66.6%, and 33.3%, respectively. As a modification example, a method by which BSs exchange information on the probability that each subframe of an SFG is used for UL transmission with each other can be considered. Moreover, a method by which BSs exchange information on the number of fixed DL subframes, the number of flexible subframes, and the number of fixed UL subframes in an SFG with each other can also be considered.

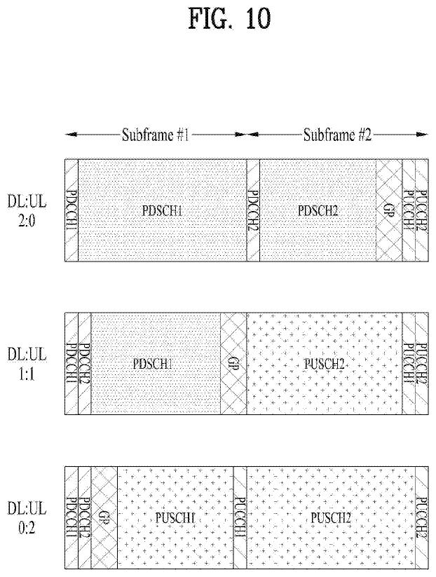

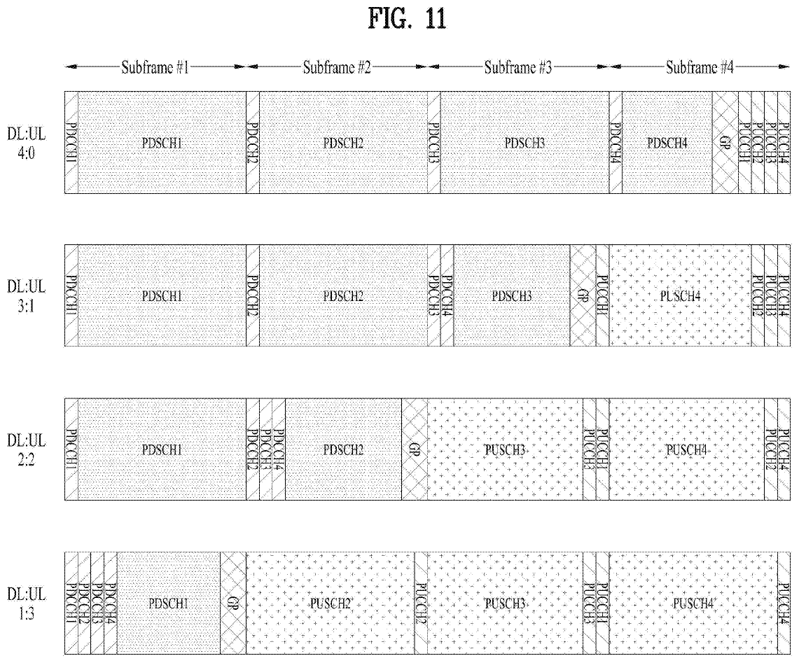

FIG. 10 illustrates DL/UL configurations when an SFG has a length of two subframes according to another embodiment of the present invention, and FIG. 11 illustrates DL/UL configurations when an SFG has a length of four subframes according to a further embodiment of the present invention.

If the length of an SFG composed of a plurality of subframes increases, the data transmission efficiency increases. However, in the case of emergency data, there occurs a problem that the transmission latency increases. Thus, the BS needs to rapidly change the SFG length based on the characteristics of data to be served. When a new SFG starts after a specific SFG ends, the BS may determine the length of the new SFG and then inform the UE of the determined SFG length. However, this may increase the reception complexity at the UE. In particular, if the UE wakes up from the DRX mode, it is difficult for the corresponding UE to find the starting point of the SFG.

Hence, the present invention proposes a method for configuring a super SFG and maintaining the SFG length during the super SFG. For example, if a system supports SFGs composed of 1, 2, 3, and 4 subframes, a BS may configure a super SFG composed of 12 subframes or subframes of which the number is a multiple of 12 and transmit information on the SFG length to a UE via the starting subframe of the super SFG either explicitly or implicitly. By doing so, if the UE wakes up from the DRX mode, the UE can obtain the SFG length at the starting point of the super SFG.

As another example, if a system supports SFGs composed of 1, 2, and 4 subframes, a BS may configure a super SFG composed of 20 subframes or subframes of which the number is a multiple of 20. In this case, the BS may inform a UE of SFG lengths to be applied per super SFG according to the following methods.

(1) A BS may inform a UE of an SFG length through an SIB. In this case, the BS may change the SFG length one time during a period for which the SIB can be updated, that is, a system information modification period (about 640 ms). Thus, the super SFG may be equal to the system information modification period.

In this case, the BS may transmit SFG change notification on a Paging CHannel (PCH) to change the SFG length so that UEs can receive SIB information again. The UE obtains the SFG length information to be applied to the next super SFG (i.e., system information modification period) from the updated SIB information.

(2) As a modification example of method (1), since the amount of information on an SFG length is not large, a BS may transmit information on the SFG length to be applied to the next super SFG (i.e., system information medication period) to a UE through a PCH.

(3) A BS may inform a UE of an SFG length by using common DCI, which is transmitted on a PDCCH. Since the common DCI is transmitted in the first subframe of each super SFG, it can be used to inform the SFG length to be applied to the corresponding super SFG. Alternatively, the BS may inform the UE of the SFG length to be applied to the next super SFG by transmitting the common DCI in multiple subframes designated as the super SFG. Additionally, information on the SFG length to be applied to the current or next super SFG may be transmitted through a channel designed therefor.

(4) A BS may inform a UE of an SFG length by using dedicated DCI, which is transmitted on a PDCCH. In other words, all DCI may include information on the SFG length, or partial DCI that is transmitted in some subframes may include information on the SFG length to be applied to the next super SFG.

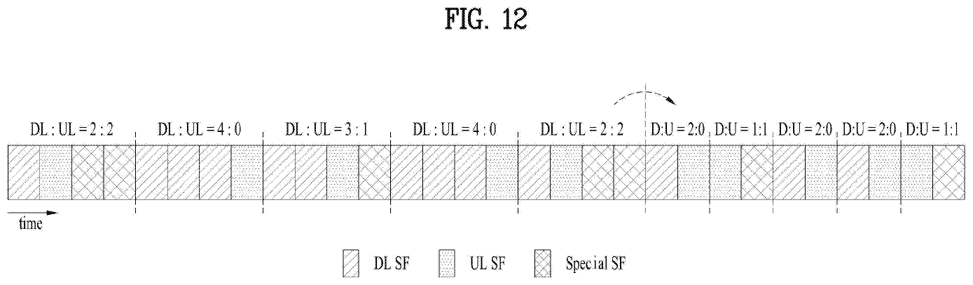

FIG. 12 illustrates a configuration where an SFG length is switched from four subframes to two subframes according to the present invention. The SFG length changed as shown in FIG. 12 may be transmitted according to one of the above-described methods. In FIG. 12, a special subframe may mean a subframe including a guard period with a predetermined length. In this specification, a subframe including a guard period with a predetermined length can be referred to as a special subframe.

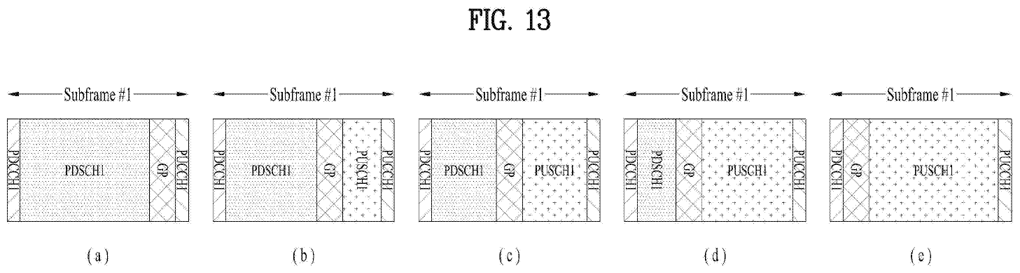

FIG. 13 illustrates SFG configurations according to the present invention when an SFG has a length of one subframe.

As shown in FIG. 13, when the SFG length is one subframe, each subframe includes a GP, a DL transmission region, and a UL transmission region. In this case, the subframe may have one of the subframe structures shown in FIG. 13(a) to FIG. 13(e).

First, FIG. 13(a) shows that only DL data is transmitted in one subframe. In other words, UL data is not transmitted in the subframe shown in FIG. 13(a).

FIG. 13(b) shows that DL and UL data are transmitted in one subframe. In particular, FIG. 13(b) shows a DL heavy type of subframe structure where the size of the transmitted DL data is larger than that of the transmitted UL data.

FIG. 13(c) shows that DL and UL data are transmitted in one subframe. In particular, FIG. 13(b) shows a DL-UL comparable type of subframe structure where the size of the transmitted DL data is similar to that of the transmitted UL data.

FIG. 13(d) shows that DL and UL data are transmitted in one subframe. In particular, FIG. 13(d) shows a UL heady type of subframe structure where the size of the transmitted UL data is larger than that of the transmitted DL data.

FIG. 13(e) shows that only UL data is transmitted in a single subframe. In other words, DL data is not transmitted in the subframe unlike FIG. 13(a).

When an SFG is composed of one subframe as shown in FIG. 13, a BS may inform a neighboring BS of the subframe type which will be used (e.g., one of the subframe types shown in FIG. 11(a) to FIG. 13(e)) through X2 signaling in order to control BS-to-BS interference. Alternatively, the BS may transmit information on the probability that each OFDM symbol in the subframe is used for DL transmission to the neighboring BS. Further, the BS may transmit information about the number of OFDM symbols used for DL transmission in the subframe and the number of OFDM symbols used for UL transmission in the subframe to the neighboring BS.

As another example, the BS may divide one subframe into a plurality of mini-subframes and share, with the neighboring BS, information on the probability that each mini-subframe is used for DL transmission. For example, one subframe may be divided into three or four mini-subframes.

As a further example, the BS may share information on the number of fixed DL mini-subframes in one subframe and the number of fixed UL mini-subframes in the subframe with the neighboring BS.

As still a further example, the BS may share the frame structure applied to an SFG with a predetermined length with the neighboring BS through a separate frame configuration.

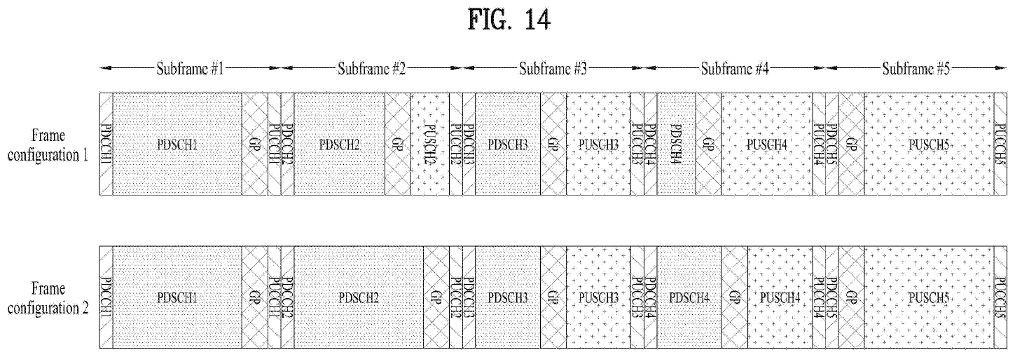

FIG. 14 illustrates frame configurations according to the present invention.

The BS may configure frame configurations, each of which has a predetermined length, by using combinations of the subframes shown in FIG. 13 where the SFG length is set to one subframe (or subframes each having the structure similar to that of the special subframe) as shown in FIG. 14. For example, the frame configurations shown in FIG. 14 may be indexed as frame configuration 1 and frame configuration 2, respectively.

In this case, some restrictions may be imposed on the frame configurations according to the present invention. For example, in a combination of subframes each having the SFG length set to one subframe (or subframes each having the structure similar to that of the special subframe) as shown in the frame configurations of FIG. 14, a subframe located ahead in the timed domain may have a DL transmission region equal to or greater than those of others. In other words, in a specific frame configuration, the DL transmission region of the nth subframe may be equal to or larger than that of the (n+1)th subframe. As another example, a subframe located at the rear in the time domain may have a DL transmission region equal to or greater than those of others.

In FIG. 14, frame configuration 1 is obtained by arranging the five types of subframes shown in FIG. 11 in descending order of their DL data transmission region sizes, and frame configuration 2 is obtained by arranging the subframe of FIG. 13(a) two times, arranging the subframe of FIG. 13(c) two times, and arranging the subframe of FIG. 13(e) one time.

Although FIG. 14 shows that one frame configuration is composed of five subframes for convenience of description, the length of the frame configuration may be set more than or less than the five subframes.

The BS may inform the UE of such a frame configuration to allow the UE to know DL/UL data transmission periods in advance. By doing so, the signaling overhead required for scheduling data transmission at the UE can be reduced.

In addition, to control BS-to-BS interference, the BS may exchange, with the neighboring BS, information (e.g., frame configuration index information) on the frame configuration which the corresponding BS uses or information (e.g., frame configuration index information) on the frame configuration which the corresponding BS desires the neighboring BS to use through an X2 interface.

The above-described configurations can be summarized as follows.

A UE receives information on the length of a subframe group comprising at least one subframe from a BS.

In this case, the information on the length of the subframe group may be transmitted via at least one of a Master Information Block (MIB), a System Information Block (SIB), a Paging CHannel (PCH), Radio Resource Control (RRC) signaling, and a Physical Downlink Control CHannel (PDCCH). In addition, the information on the length of subframe group may be transmitted at an interval of a predetermined number of subframe groups (e.g., per super SFG).

Next, the UE obtains information on the configuration of the at least one subframe in the subframe group.

The UE may use various methods to obtain information on the configuration of the at least one subframe in the subframe group. For example, the UE may receive the information on the configuration of the at least one subframe in the subframe group from the BS. As another example, the UE may obtain the information on the configuration of the at least one subframe in the subframe group from the PDCCH detected in the at least one subframe.

Hereinafter, another example of the aforementioned configuration will be described. First, it is assumed that one subframe group sequentially include three subframes: first, second, and third subframes in the time domain as shown in FIG. 9. In this case, if the UE detects, from the first subframe, grant information for a Physical Uplink Shared CHannel (PUSCH) in the second subframe or grant information for a PUSCH in the third subframe, the UE may consider that the first subframe is set as a downlink resource and the second and third subframes are set as uplink resources as in the subframe group of FIG. 9 where the ratio of DL to UL is 1:2 (DL:UL=1:2).

As described above, the UE may receive, from the BS, either or both of control information or data on downlink resources configured according to the configuration of the at least one subframe in the subframe group and transmit, to the BS, either or both of control information or data on uplink resources configured according to the configuration of the at least one subframe in the subframe group. The subframe group may include one guard period as shown in the examples of FIGS. 9 to 11.

In this case, as shown in the examples of FIGS. 9 to 11, the subframe group may sequentially include the downlink resources, the guard period, and the uplink resources in the time domain.

At this time, the guard period may be allocated to two symbols in the time domain.

In addition, the locations of first downlink resources used by the UE to receive control information from the BS and second downlink resources used by the UE to receive data from the BS may be configured based on the information on the configuration of the at least one subframe in the subframe group. In addition, the locations of first uplink resources used by the UE to transmit control information to the BS and second uplink resources used by the UE to transmit data to the BS may be configured based on the information on the configuration of the at least one subframe in the subframe group.

In response to the above-described UE operation, the BS may transmit, to the UE, information on the length of a subframe group comprising at least one subframe, transmit, to the UE, information on the configuration of the at least one subframe in the subframe group, transmit, to the UE, either or both of control information and data on downlink resources configured according to the configuration of the at least one subframe in the subframe group, and receive, from the UE, either or both of control information and data on uplink resources configured according to the configuration of the at least one subframe in the subframe group.

In this case, the BS may transmit the information on the length of the subframe group and the information on the configuration of the at least one subframe in the subframe group to a neighboring BS. To this end, an X2 interface or an X2 signaling method may be applied.

### 4. Device Configuration

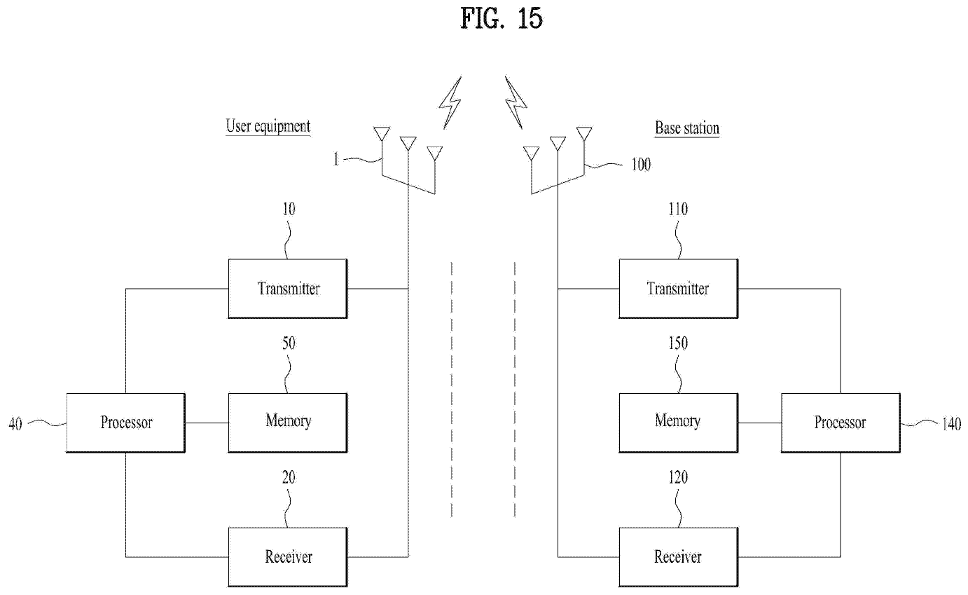

FIG. 15 is a diagram illustrating configurations of a UE and a BS capable of being implemented by the embodiments proposed in the present invention. The UE and BS shown in FIG. 15 operate to implement the embodiments of the method for transmitting and receiving a signal between the UE and the base station.

The UE 1 may act as a transmission end on UL and as a reception end on DL. The BS (eNB or gNB) 100 may act as a reception end on UL and as a transmission end on DL.

That is, each of the UE and BS may include a Transmitter (Tx) 10 or 110 and a Receiver (Rx) 20 or 120, for controlling transmission and reception of information, data, and/or messages, and an antenna 30 or 130 for transmitting and receiving information, data, and/or messages.

Each of the UE and BS may further include a processor 40 or 140 for implementing the afore-described embodiments of the present disclosure and a memory 50 or 150 for temporarily or permanently storing operations of the processor 40 or 140.

With the above-described configuration, the UE 1 may be configured to: receive information on the length of a subframe group comprising at least one subframe from the BS 100 through the receiver 20; obtain information on the configuration of the at least one subframe in the subframe group; receive, through the receiver 20 from the BS 100, either or both of control information or data on downlink resources configured according to the configuration of the at least one subframe in the subframe group; and transmit, through the transmitter 10 to the BS 100, either or both of control information or data on uplink resources configured according to the configuration of the at least one subframe in the subframe group. In this case, the subframe group may include one guard period.

With the above-described configuration, the BS 100 may be configured to: transmit, through the transmitter 110 to the UE 1, information on the length of a subframe group comprising at least one subframe; transmit, through the transmitter 110 to the UE 1, information on the configuration of the at least one subframe in the subframe group; transmit, through the transmitter 110 to the UE 1, either or both of control information and data on downlink resources configured according to the configuration of the at least one subframe in the subframe group; and receive, through the receiver 120 from the UE 1, either or both of control information and data on uplink resources configured according to the configuration of the at least one subframe in the subframe group. In this case, the subframe group may include one guard period.

The Tx and Rx of the UE and the BS may perform a packet modulation/demodulation function for data transmission, a high-speed packet channel coding function, OFDM packet scheduling, TDD packet scheduling, and/or channelization. Each of the UE and the base station of FIG. 15 may further include a low-power Radio Frequency (RF)/Intermediate Frequency (IF) module.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a Multi Mode-Multi Band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g. CDMA 2000, WCDMA, etc.).

Embodiments of the present disclosure may be achieved by various means, for example, hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present disclosure may be implemented in the form of a module, a procedure, a function, etc. performing the above-described functions or operations. A software code may be stored in the memory 180 or 190 and executed by the processor 120 or 130. The memory is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The present disclosure is applicable to various wireless access systems including a 3GPP system, and/or a 3GPP2 system. Besides these wireless access systems, the embodiments of the present disclosure are applicable to all technical fields in which the wireless access systems find their applications. Moreover, the proposed method can also be applied to mmWave communication using an ultra-high frequency band.

What is claimed is:

1. A method for transmitting and receiving signals to and from a base station (BS) by a user equipment (UE) in a wireless communication system, the method comprising:
receiving, from the BS, information on a length of a subframe group comprising at least one subframe;
obtaining information on a configuration of the at least one subframe in the subframe group;
receiving, from the BS, either or both of control information and data on downlink resources configured according to the configuration of the at least one subframe in the subframe group; and
transmitting, to the BS, either or both of control information and data on uplink resources configured according to the configuration of the at least one subframe in the subframe group,
wherein the subframe group includes one guard period.

2. The method of claim 1, wherein the information on the length of the subframe group is transmitted via at least one of a Master Information Block (MIB), a System Information Block (SIB), a Paging CHannel (PCH), Radio Resource Control (RRC) signaling, and a Physical Downlink Control CHannel (PDCCH).

3. The method of claim 1, wherein the information on the length of the subframe group is transmitted at an interval of a predetermined number of subframe groups.

4. The method of claim 1, wherein the subframe group sequentially comprises the downlink resources, the guard period, and the uplink resources in a time domain.

5. The method of claim 1, wherein the information on the configuration of the at least one subframe in the subframe group is obtained by receiving it from the BS.

6. The method of claim 1, wherein the information on the configuration of the at least one subframe in the subframe group is obtained from a Physical Downlink Control CHannel (PDCCH) detected in the at least one subframe.

7. The method of claim 6, wherein when the subframe group sequentially comprises three subframes: first, second, third subframes in a time domain and when grant information for a Physical Uplink Shared CHannel (PUSCH) in the second subframe or grant information for a PUSCH in the third subframe is detected in the first subframe of the subframe group, the first subframe is set as a downlink resource and the second and third subframes are set as uplink resources.

8. The method of claim 1, wherein locations of first downlink resources used by the UE to receive the control information from the BS, second downlink resources used by the UE to receive data from the BS, first uplink resources used by the UE to transmit the control information to the BS, and second uplink resources used by the UE to transmit the data to the BS are configured based on the information on the configuration of the at least one subframe in the subframe group.

9. The method of claim 1, wherein the guard period is allocated to two symbols in a time domain.

10. A method for transmitting and receiving signals to and from a user equipment (UE) by a base station (BS) in a wireless communication system, the method comprising:
transmitting, to the UE, information on a length of a subframe group comprising at least one subframe;
transmitting, to the UE, information on a configuration of the at least one subframe in the subframe group;
transmitting, to the UE, either or both of control information and data on downlink resources configured according to the configuration of the at least one subframe in the subframe group; and
receiving, from the UE, either or both of control information and data on uplink resources configured according to the configuration of the at least one subframe in the subframe group,
wherein the subframe group includes one guard period.

11. The method of claim 10, further comprising transmitting the information on the length of the subframe group and the information on the configuration of the at least one subframe in the subframe group to a neighboring BS.

12. The method of claim 11, wherein the information on the length of the subframe group and the information on the configuration of the at least one subframe in the subframe group is transmitted via an X2 interface or X2 signaling.

13. A user equipment (UE) for transmitting and receiving signals to and from a base station (BS) in a wireless communication system, the UE comprising:
a transmitter;
a receiver; and
a processor connected to the transmitter and the receiver,
wherein the processor is configured to:
receive, through the receiver from the BS, information on a length of a subframe group comprising at least one subframe;
obtain information on a configuration of the at least one subframe in the subframe group;
receive, through the receiver from the BS, either or both of control information and data on downlink resources configured according to the configuration of the at least one subframe in the subframe group; and
transmit, through the transmitter to the BS, either or both of control information and data on uplink resources configured according to the configuration of the at least one subframe in the subframe group, and
wherein the subframe group includes one guard period.

14. A base station (BS) for transmitting and receiving signals to and from a user equipment (UE) in a wireless communication system, the BS comprising:
a transmitter;
a receiver; and
a processor connected to the transmitter and the receiver,
wherein the processor is configured to:
transmit, through the transmitter to the UE, information on a length of a subframe group comprising at least one subframe;
transmit, through the transmitter to the UE, information on a configuration of the at least one subframe in the subframe group;
transmit, through the transmitter to the UE, either or both of control information and data on downlink resources configured according to the configuration of the at least one subframe in the subframe group; and
receive, through the receiver from the UE, either or both of control information and data on uplink resources configured according to the configuration of the at least one subframe in the subframe group, and
wherein the subframe group includes one guard period.
